(19) United States
(12) Patent Application Publication
(10) Pub. No.: US 2012/0239561 A1
(43) Pub. Date: Sep. 20, 2012

(54) METHOD AND APPARATUS FOR UNIQUE IDENTIFICATION OF ACCOUNT AND FOR BILLING AN ACTIVITY IN AN OPEN NETWORK

(76) Inventors: Ido Sharon, Zur Hadassa (IL); Moshe Kalige, Givat Zeev (IL); Yuval Cohen-Hamuz, Herzlia (IL)

(21) Appl. No.: 13/419,654

(22) Filed: Mar. 14, 2012

Related U.S. Application Data
(60) Provisional application No. 61/452,301, filed on Mar. 14, 2011.

(51) Int. Cl. G06Q 20/14

(52) U.S. Cl. 705/40

(57) ABSTRACT

System and method are provided to enable a service carrier (mobile phone, fixed line phone, Internet provider and others) to bill its customers in an ongoing process for an ongoing service or goods by locking the IP address and the account used in the Diameter protocol and the activity done on the network.

### CROSS REFERENCE TO RELATED APPLICATIONS

This Application claims the benefit of U.S. Provisional Application Ser. No. 61/452,301, filed Mar. 14, 2011, which is hereby incorporated by reference in its entirety.

### BACKGROUND OF THE INVENTION

In telecom infrastructure there is a way for authentication, authorization and accounting (AAA) the inbound traffic of a customer. Most modern systems use the Diameter AAA protocol. Once the inbound traffic is connected to the network there is no simple way to determine who is doing what on the internet (Lawful Interception (LI) systems used by law enforcement entities in cases of cybercrime are complex to operate and used for content monitoring in rare cases).

Information technology (IT) systems use pre-registration (e.g. username and password) to determine who is the paying customer. This methodology is a little inconvenient. The user needs to fill-in personal billing information in some kind of clearing entity (such as PayPal and Apple-Store) that can use credit card, bank account mechanism and the like. Although inconvenient, there are successful examples for small payments architectures like PayPal and Apple App store which sell small Apps as well as other vendors who use the above or similar architectures for enabling purchase of goods 1 services involving small payments.

This methodology is not suitable for micropayments where the transaction involves payment of sub cents in each payment. So if a carrier or vendor wants to bill the customer per usage (like a cent a minute), it is not practical to make the user to register and enter his username and password every few seconds.

### SUMMARY OF THE INVENTION

One object of the present invention is to enable a service carrier (Mobile phone, Fixed line phone, Internet provider and others) to bill its customers in an ongoing process for an ongoing service or goods by locking the IP address and the account used in the Diameter protocol and the activity done on the network. In today's systems this can be done only in the carrier closed garden (i.e. within the carrier's internal network).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a prior art internet service network;

FIG. 2 is a schematic illustration of an operator infrastructure for providing internet access according to one embodiment of the present invention;

FIG. 3 is a flowchart of a method according to one embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

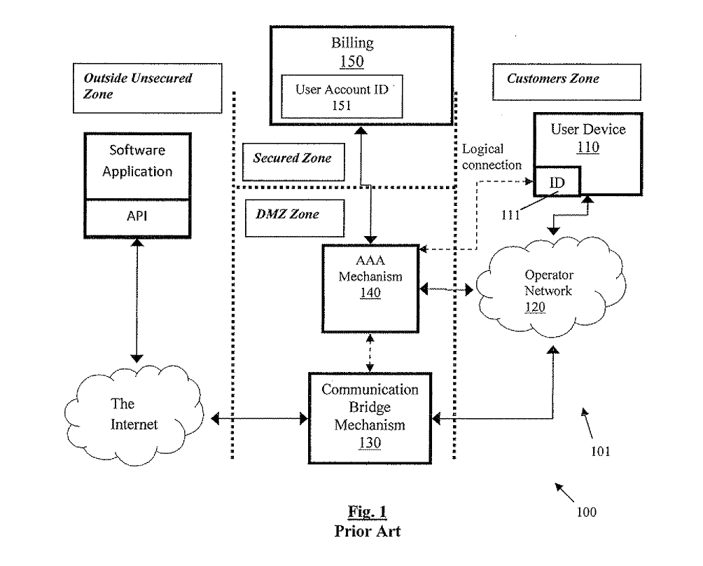

Reference is now made to FIG. 1, which is a schematic illustration of a prior art communication network 100. An operator (e.g. Mobile radio-telephone network, such as cellular phone network, Fixed telephone network, Internet Service Provider (ISP), etc.) manages an operator communication system 101 that provides services to plurality of user devices 110 (for simplicity the figure only describes one). The services can be transmission of voice, text, data and more.

As may be seen in FIG. 1, network 100 may comprise a plurality of user devices 110, such as cellular phones, personal computers, laptop computers etc.

Each user device 110 may have a corresponding unique User Account ID 151 within the operator billing mechanism 150. Billing mechanism 150 is responsible to collect the payment from the user payment means (e.g. bank account, credit card).

User device 110 may have an identification mechanism 140 that has the general form of an AAA (Authenticate, Authorize and Account) within the operator control and an ID mechanism 111, such as a Subscriber Identification Module (SIM), an Internet Protocol (IP) address identifier module, Digital Subscriber Line Access Multiplexer (DSLAM) port, and the like, within the user device 110. This may provide the operator the ability to uniquely identify the user for billing purposes, for services provided to user device 110 within operator system 101 (known in the art as Closed Garden).

ID mechanism 111 in user device 110 may be linked to user account ID 151. Such a link can be implemented using database table that holds pairs of entries—ID mechanism 111 and user account ID 151. All services obtained by user device 110 within operator system 101 (comprising user device 110, operator network 120, AAA mechanism 140 and billing server 150) may be controlled by the operator and thus allow the operator to bill per use or per duration of use.

As may be further seen in FIG. 1, most operators provide internet services through Internet Service Providers (ISP's) or directly by themselves. The service may enable user devices 110 to access the Internet 160 via operator network 120. This service may be billed by the operator through an AAA mechanism. The control over the communication may be done by a Communication Bridge mechanism 130 (e.g. BRAS, LAC-LNS and the like) that is able to convey communication traffic from the user device through operator network 120 to the Internet and vice-versa.

AAA mechanism 140 may be linked to Communication Bridge 130 and may authorize the user device 110 connection to the Internet.

The content of the communication between the user device 110 and the Internet is neither controlled nor accessible to the operator. Some of the operators use Deep Packet Inspection (DPI) as part of the Communication Bridge Mechanism 130 in order to control the communication content for purposes such as parental control, regulation, lawful interception and the like.

The connection to the Internet enables the users to access services that are not in operator system 101 but on The Internet (Open Garden).

Providers of services on the Internet may manage billing of their services using additional AAA mechanism 180 that is not linked to operator AAA mechanism 140 nor uses the ID mechanism 111 of user device 110.

Typically additional AAA mechanism 180 of providers of services on the Internet is done by registration that uses unique name and password to establish a billable session.

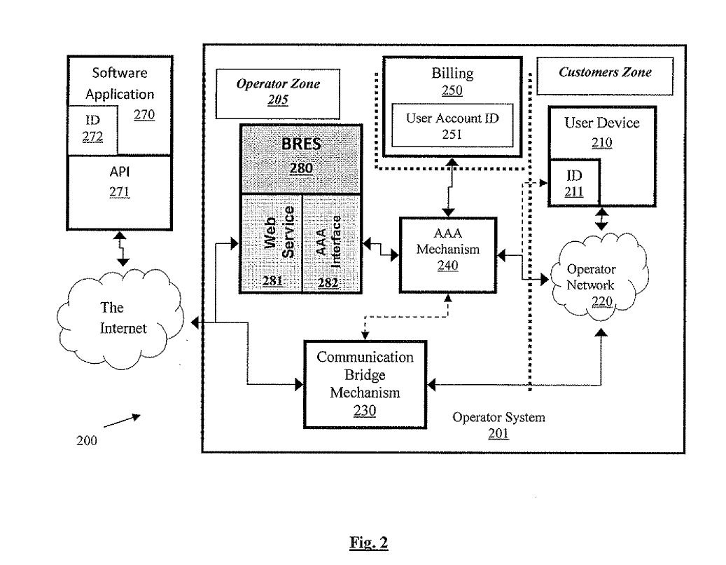

Reference is now made to FIG. 2 which is a schematic illustration of an operator infrastructure for providing internet access according to one embodiment of the present invention. As may be seen in FIG. 2, Operator system 201 is comprised from at least one user device 210 (in user zone 212), an AAA mechanism 240, a billing mechanism 250 and a communication bridge mechanism 230 (all in operator zone 205).

User device 210 may be a cellular phone, a laptop computer, a personal computer (PC) or any other device that may connect to an operator network 220 and wherethrough to The Internet 260.

User device 210 may have an identification mechanism that is generally built from an AAA (Authenticate, Authorize and Account) mechanism 240 within the operator control and an ID mechanism 211, such as a Subscriber Identification Module (SIM), an Internet Protocol (IP) address, and the like, within user device 210. This may provide the operator the ability to uniquely identify the user for billing purposes, for services provided to user device 210 within operator system 201.

ID mechanism 211 in user device 210 may be linked to user account 251, through an operator network 220 to AAA mechanism 240, which in turn may be connected to billing server 250.

Operator system 201 may further comprise a Billing, Registration & Event passing Solution (BRES) router 280.

BRES router 280 may comprise a web service interface 281 to communicate with an event generator agent 271, which is an Application Program Interface (API) embedded in software applications 270 designed to operate with system 200 in order to allow such software applications to communicate with BRES router 280 in order to bill a user device account in billing mechanism 250 within operator system 201. Each software application provider receives from the Operator a unique identifier ID 272. Such an identifier may contain a provider number and a service number. BRES router 280 may further comprise an AAA interface 282 to communicate with AAA mechanism 240 to generate billing for the operator through standard AAA Protocol (such as Diameter protocol, Radius protocol, etc.).

An event is a billable activity. Such an activity may be User's input, downloading of a file, getting into a next game level and the like. This activity may be rerouted or reflected by event generator agent 271 to BRES router 280. BRES router 280 can uniquely associate an activity (identified according to its ID 272) and the user account as all required information is accessible to BRES router 280. A user (not shown) using user device 210 may not necessarily be aware that part of his activity is rerouted to BRES router 280.

Event generator 271 may be an Application Program Interface (API) available to software applications programmers to be embedded in applications that require payments. According to some embodiments of the present invention, a range of API and development tools may be provided so the programmer of a software application can control all aspects of the billing process. Because the actual billing is uniquely identified in BRES router 280 it can assure safe and accurate billing of user account 251 and prevent any external interference in the billing process.

According to some embodiments of the present invention BRES router 280 can reside in the operator zone 205 thus giving BRES router 280 access both to the Internet and to AAA Mechanism 240. AAA Mechanism 240 may be a Signaling Router (like DRA-Diameter Router agent) or Signaling Clients and Servers (such as Diameter Clients, Radius Clients, etc.).

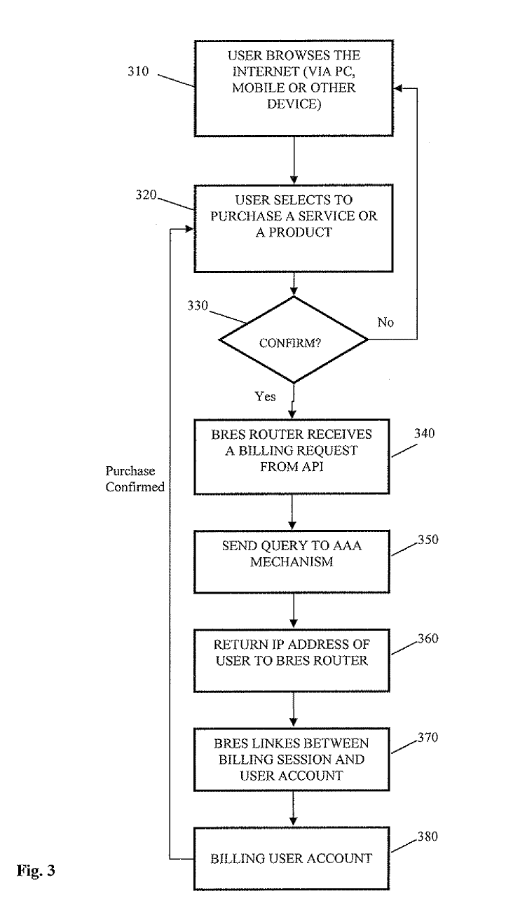

Reference is now made to FIG. 3 which is a flowchart of a method according to one embodiment of the present invention. As may be seen in Block 310 a user may browse the Internet, Such browsing may be made using a Personal Computer (PC) or a mobile device (e.g. Smart-Phone, iPAD) and the like. A service or a product may be offered, or available to the user in an Internet site. User may decide to purchase a service or a product [Block 320]. The user may be prompted to confirm the payment [Block 330] (e.g. message box). If the user may confirm, information may be sent, through event generator 271 Software API, to the Operator [Block 340]. Such information may comprise software application provider ID 272 and user ID 211 (typically encrypted). According to an embodiment of the present invention, the operator systems may authenticate the user and the provider and may produce billing activity. A confirmation is sent to the user and may be displayed (e.g. a message box). The software application provider ID 272 may comprise the programmer ID, the service ID and the service price tag.

As may be seen in Block 340 BRES router 280 receives a billing request from the event generator 271 API that is embedded into an Internet application. Such a request may contain, as mentioned above, the user ID the programmer ID the service ID and the service price tag. When BRES router 280 receives a request, a query is sent to AAA mechanism 240 [Block 350]. In response, AAA mechanism may return a user IP Address associated with the user ID received from the API through BRES router 280 [Block 360]. With the information received from AAA mechanism 240 BRES router 280 can uniquely identify the user and the software application provider and make a link between the billing session and the user account ID 251 [Block 370].

Once BRES router 280 has established that link it can make billing requests (like by minute, by one time fee, etc.) as any other service the operator provides to his customers (as if it was in the closed garden) [Block 380].

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An operator system for providing internet access comprising:
at least one user device;
at least one Authenticate, Authorize and Account (AAA) mechanism;
a billing mechanism;
a communication bridge mechanism; and
a Billing, Registration & Event passing Solution (BRES) router;
wherein said BRES router comprises:
a web service interface to communicate with an event generator agent; and
an AAA interface to communicate with AAA mechanism to generate billing for the operator through standard AAA Protocol.

2. The system according to claim 1 wherein said user device comprises an identification mechanism, said mechanism comprises an AAA mechanism within the system's operator control and an ID mechanism to allow said operator to uniquely identify said user device.

3. The system according to claim 2 wherein said ID mechanism is linked to a user account and to AAA mechanism through an operator network; said AAA mechanism is further connected to said billing mechanism.

4. The operator system according to claim 3 wherein said event generator agent is an Application Program Interface (API) embedded in software applications designed to operate with said operator system in order to allow said software applications to communicate with said BRES router in order to bill said user account in said billing mechanism within said operator system.

5. The system according to claim 4 wherein said software application further comprises an ID number to identify the provider of said software application.

6. The system according to claim 5 wherein said BRES router uniquely associates at least one billable event, identified according to said ID number, and said user account to assure safe and accurate billing of user account and prevent any external interference in a billing process.

7. The system according to claim 1 wherein said BRES router is located in an operator zone to provide BRES router access both to the Internet and to said AAA Mechanism.

8. The system according to claim 1 wherein said AAA mechanism is selected from a list including: signaling router and signaling clients and servers.

9. A method for billing a user account by a system operator for activities in an open network, the method comprising:
providing a plurality of software applications available to a user over an open network;
receiving at BRES router a billing request from an event generator API embedded in a software application;
sending user information and software application provider information to said operator by said API embedded in said software application;
authenticating the identity of said user and said software application provider; and
billing user account.

10. The method of claim 9 wherein said provider information comprises a software application provider ID; and wherein said user information comprises a user ID.

11. The method according to claim 10 wherein said software application provider ID comprises at least one of: a programmer ID, a service ID and a service price tag.

12. The method according to claim 9 further comprising sending a confirmation request to said user prior to billing said user account.

13. The method according to claim 9 further comprising sending a confirmation to said user that said user account was billed.

14. The method according to claim 9 further comprising
sending a query to AAA mechanism from said BRES router upon receipt of said billing request, and
receiving from AAA mechanism in return to said query a user IP address associated with said user ID received from said API through said BRES router.

15. The method according to claim 14 further comprising uniquely identifying said user and said software application provider and making a link between a billing session and said user account.

16. The method according to claim 15 wherein after making said link between a billing session and said user account, making billing requests every predefined time interval.
